(19) United States
(12) Patent Application Publication
(10) Pub. No.: US 2020/0117642 A1
(43) Pub. Date: Apr. 16, 2020

(54) DETERMINING OPTIMAL DATA SIZE FOR DATA DEDUPLICATION OPERATION

(71) Applicant: INTEL CORPORATION, Santa Clara, CA (US)

(72) Inventors: Malini K. BHANDARU, San Jose, CA (US); Anjaneya R. CHAGAM REDDY, Chandler, AZ (US); Ganesh Maharaj MAHALINGAM, Santa Clara, CA (US); Tushar GOHAD, Phoenix, AZ (US); Wei CHEN, Shanghai (CN); Yingxin CHENG, Hangzhou (CN); Xiaoyan LI, Shanghai (CN); Qiaowei REN, Shanghai (CN); Chunmei LIU, San Jose, CA (US)

(21) Appl. No.: 16/617,366

(22) PCT Filed: Jun. 30, 2017
(86) PCT No.: PCT/CN2017/091022

§ 371 Date: Nov. 26, 2019

(51) Int. Cl. G06F 16/174; G06F 3/06

(52) U.S. Cl. CPC G06F 16/1748; G06F 3/0673; G06F 3/0641; G06F 3/0608

(57) ABSTRACT

A storage resource may be coupled via an interface with a processing device that receives a data object associated with a request to store the data object at the storage resource. A type of workload associated with the data object that is associated with the request to store the data object at the storage resource may be identified. A size of a data block of the data object may be determined based on the identified type of workload. Furthermore, a deduplication operation may be performed for the data object based on the determined size of the data block

### TECHNICAL FIELD

Embodiments described herein generally relate to data deduplication, and more specifically, relate to determining optimal data size for a data deduplication operation.

### BACKGROUND

Various techniques may be used to provide data deduplication. In general, data deduplication may refer to a process to eliminate duplicate copies of data stored in a computer system. For example, unique data blocks may be stored at a storage resource. As a subsequent data block is received to be stored at the storage resource, the data blocks currently stored at the storage resource may be compared with the subsequent data block. If there are no copies of the subsequent data block currently stored at the storage resource, then the subsequent data block may be stored at the storage resource. Otherwise, if one of the data blocks currently stored at the storage resource is a duplicate of the subsequent data block, then the subsequent data block may not be stored at the storage resource. Instead, a reference to the location in the storage resource where the currently stored data block that is the duplicate of the subsequent data block may be provided.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example of a computing environment including an example solid-state drive in accordance with some embodiments of the present disclosure.

FIG. 2 is a flow diagram of an example method to determine a size of a data block used in a data deduplication operation in accordance with some embodiments.

FIG. 3A illustrates an example of a separating or dividing of a data object into data blocks of a first size in accordance with some embodiments of the present disclosure.

FIG. 3B illustrates another example of the separating or dividing of a data object into data blocks of a second size in accordance with some embodiments of the present disclosure.

FIG. 4 is a flow diagram of a method to identify a workload of a data object in accordance with some embodiments of the disclosure.

FIG. 5 illustrates an example method to perform a data deduplication operation based on a determined size of a data block in accordance with some embodiments of the disclosure.

FIG. 6 is a block diagram of an example computer system associated with the solid-state drive.

FIG. 7 is a block diagram of another example computer system associated with the solid-state drive.

### DETAILED DESCRIPTION

Aspects of the present disclosure are directed to determining an optimal data size for a data deduplication operation. In general, the data deduplication operation may be used to store data at a storage system that may be represented by one or more storage devices. Examples of the storage devices may include, but are not limited to, a solid-state drive, hard disk drives, etc. The storage system may thus include a group or cluster of storage devices.

The data deduplication operation may be performed as data objects (e.g., files) are received to be stored at the storage system (i.e., inline deduplication). Each data object may be divided or separated into multiple separate data blocks (i.e., chunks). Each of the data blocks for a data object may then be compared with other data blocks that are currently stored at the storage system. In some embodiments, to perform a faster comparison, instead of directly comparing data blocks, the data deduplication operation may compare hash values. For example, the data deduplication operation may perform a hash function on each of the data blocks to calculate hash values for each of the data blocks that correspond to a data object. The hash values for a particular data block may then be compared with the hash values of other data blocks that are currently stored at the storage system. For example, the hash value for a data block of a received data object may be compared with hash values for data blocks that were previously received and stored at the storage system. If the hash value for the particular data block matches with any hash value of a data block currently stored at the storage system, then the received data block may be considered a duplicate of another data block that is currently stored at the storage system. Instead of storing the received data block, a reference (e.g., a pointer) to the duplicate data block that has already been stored is stored Otherwise, if the hash value of the received data block does not match with any hash values of data blocks currently stored, then the data block may be stored at the storage system along with its hash value, the latter for use in future comparisons against any subsequently received data block. Thus, the data deduplication operation may be performed for each individual data block of the data object by comparing each individual data block (or its corresponding hash value) to another data block that is currently stored at the storage system.

The size of the data block used during the data deduplication operation may impact the performance of a storage system. For example, more duplicate data blocks may be identified if the size of the data blocks used during the data deduplication operation is smaller than when the size of the data blocks is larger as a data object may be separated or divided into a larger number of data blocks that are each compared with data blocks currently stored at the storage system. As an example, if a data block corresponded to a sentence and if a difference between two sentences is a single character (e.g., an added punctuation character), then a comparison of two such data blocks may not identify a duplicate data block (e.g., a duplicate sentence). However, if the size of a data block is a portion of a sentence, then different portions of the two sentences may be identified as being a duplicate and only the portion of one of the sentences that includes the additional character may not be identified as a duplicate. As a result, more portions of the data object may be replaced with references to duplicate data blocks that are currently stored and fewer portions of the data object may need to be stored at the storage system. However, a smaller size of data blocks used during the data deduplication operation may result in an increase in the amount of time to perform the data deduplication operation as more hash values may need to be generated and more comparisons between generated hash values and hash values of previously stored data blocks may be performed and the data object reference will need to include more pointers, resulting in increased representational size of the data object.

Aspects of the present disclosure may determine a size of a data block used in the data deduplication operation based on a workload of a received data object. The workload may correspond to a type of application that has generated or is used with the data object. Examples of a workload include, but are not limited to, types of word documents (e.g., text documents from particular word processing applications), types of databases (e.g., database files or snapshots), etc. The workload of the data object may be identified by any combination of inspecting the data object (e.g., parsing a portion of the data object contents), receiving an indication of an application that is associated with the data object (e.g., an application hint), a name of a file corresponding to the data object (e.g., the file extension), a size of the data object or a pattern of usage of the data object, etc. After the workload of the data object is identified, a size of a data block that is to be used during a data deduplication operation with the data object may be determined based on the identified workload. For example, a first data object of a first type of workload may be assigned a data block size of 4 kilobytes (KB) and the data deduplication operation for the first data object may be based on 4 KB data blocks of the data object. A second data object of a second type of workload may be assigned a different data block size of 8 kilobytes (KB) and the data deduplication operation for the second data object may thus be based on 8 KB data blocks of the second data object.

As such, the determining of the size of a data block to be used in a data deduplication operation based on the workload associated with a data object may improve the efficiency of a storage system. For example, the optimal or preferred data block size for different workloads may be different since the data objects are of different types and formats for different applications. If the size of a data block used in a data deduplication operation is too small, then multiple calls to the hash function and multiple comparisons may be performed between the smaller data blocks and currently stored data blocks to identify duplicates. For example, if duplicate data blocks of a particular type of workload may be identified by 8 KB data blocks, then one hashing function and one comparison may be performed as opposed to two hashing functions and at least two comparisons being performed if the data deduplication operation were to be performed with 4 KB data blocks. Furthermore, additional storage resources may be used to store more hash values from the hash function when the size of the data block is decreased.

Thus, the determining of the optimal size of the data block as described herein may reduce the storage capacity needed to store data objects as data deduplication is still performed on the data blocks of the data objects while improving storage system efficiency by reducing the number of retrievals of information (e.g., hash values) and comparison operations used during the data deduplication operation. No duplicate data may thus be stored at the storage system, resulting in less write transactions being performed at the storage devices of the storage system, which effectively increases the storage capacity of the storage devices. The fewer number of write transactions may increase the lifespan or viability of a storage device (e.g., a solid-state drive) used in the storage system. Furthermore, the fewer hashing functions and comparison operations being performed may result in an increase in performance of the writing of a data object to the storage device used in the storage system by decreasing the amount of time to store the data object as fewer data deduplication operations are being performed.

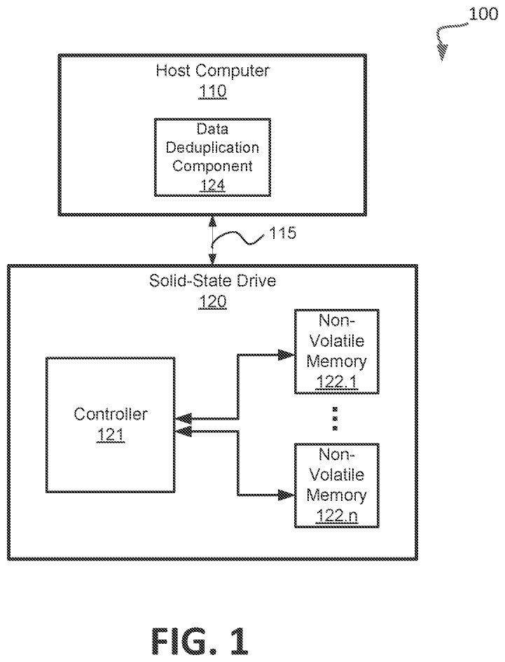

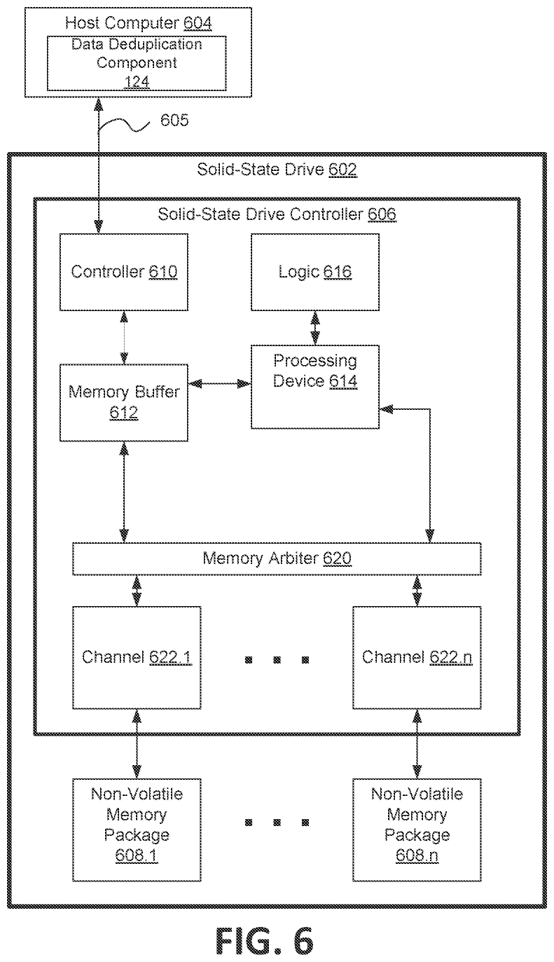

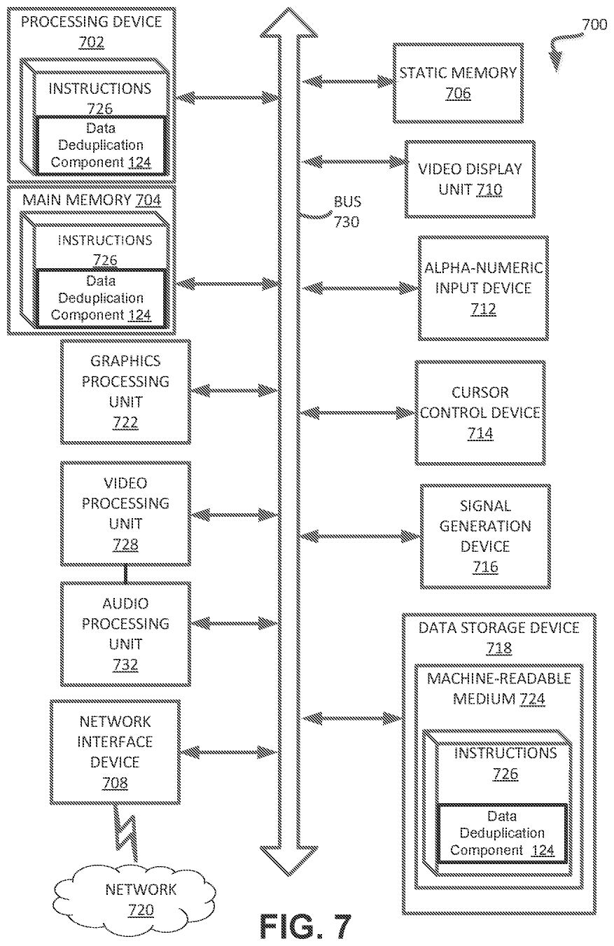

FIG. 1 illustrates an example computing environment 100 including a solid-state drive 120. In general, the computing environment 100 may include a host computer 110 that includes or is coupled to a solid-state drive 120. The host computer 110 may be a type of computing system or computing device that is operatively coupled to the solid-state drive 120. For example, an input/output (I/O) interface 115 may be used to transfer data between the host computer 110 and the solid-state drive 120. The I/O interface 115 may be arranged as a Serial Advanced Technology Attachment (SATA) interface to couple elements of the host computer 110 to the solid-state drive 120. In the same or alternative embodiments, the I/O interface 115 may be arranged as a Serial Attached SCSI (SAS) interface to couple the elements of the host computer 110 to the solid-state drive 120. In some embodiments, the I/O interface 115 may be arranged as a PCIe interface to couple the elements of the host computer 110 with the solid-state drive 120. In some embodiments, the I/O interface 115 may be a Non-Volatile Memory Express (NVMe) interface that may correspond to a logical device interface for accessing non-volatile storage media attached via a Peripheral Component Interconnect Express (PCIe) bus. The non-volatile storage media may include a flash memory and solid solid-state drives (SSDs). NVMe may be designed for accessing low latency storage devices in computer systems, including personal and enterprise computer systems, may be deployed in data centers requiring scaling of thousands of low latency storage devices. Further details with regard to the host computer 110 are described in conjunction with FIGS. 6-7.

As shown in FIG. 1, the solid-state drive 120 may include a controller 121 (also referred to as a solid-state drive (SSD) controller) and non-volatile memory 122.1 to 122.n. In some embodiments, non-volatile memory may refer to one of the non-volatile memory packages (e.g., chips or dies) and in other embodiments non-volatile memory may refer to multiple non-volatile memory packages. The controller 121 may manage data stored at the non-volatile memory 122.1 to 122.n and may communicate with the host computer 110 via the I/O interface 115. For example, the controller 121 may receive write operations from the host computer 110 via the I/O interface 115 to store data at the non-volatile memory 122.1 to 122.n and read operations from the host computer 110 to retrieve data from the non-volatile memory 122.1 to 122.n. The controller 121 may further control other such operations for the non-volatile memory 122.1 to 122.n or other components of the solid-state drive 120 such as wear leveling operations or translations between logical and physical addresses. Further details with regard to the solid-state drive 120 are described in conjunction with FIG. 6. Furthermore, aspects of the present disclosure may be used in conjunction with a pool of storage servers. The data deduplication operation may be performed for each storage server of the pool of storage servers. For example, the data deduplication operations may be in synchronization between each storage server. In alternative embodiments, a centralized data deduplication operation may be performed across the pool of storage servers (e.g., a single data deduplication agent performs the data deduplication operation for all of the storage servers in the pool).

In some embodiments, the solid-state drive 120 may be a solid-state drive (SSD) or any other such storage device. The non-volatile memory 122.1 to 122.n may include one or more chips or dies that may individually include one or more types of non-volatile memory devices. In some embodiments, the non-volatile memory devices of the non-volatile memory may be embodied as planar or three-dimensional NAND (“3D NAND”) non-volatile memory devices or NOR. However, in other embodiments, the non-volatile memory may be embodied as any combination of memory devices that use chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, Magnetoresistive random-access memory (MRAM), Spin Transfer Torque (STT)-MRAM, silicon-oxide-nitride-oxide-silicon (SONOS) memory, polymer memory such as ferroelectric polymer memory, ovonic memory, nanowire or electrically erasable programmable read-only memory (EEPROM), etc. In the same or alternative embodiments, a memory device may be a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. As previously described, the solid-state drive 120 may be arranged or configured as a solid-state drive. The disclosure also applies to Persistent Memory” and “Battery Backed DRAM, and hard disk drives (HDDs). However, examples described in the present disclosure are not limited to storage devices arranged or configured as SSDs. Thus, the present disclosure is not limited to an SSD-based storage system.

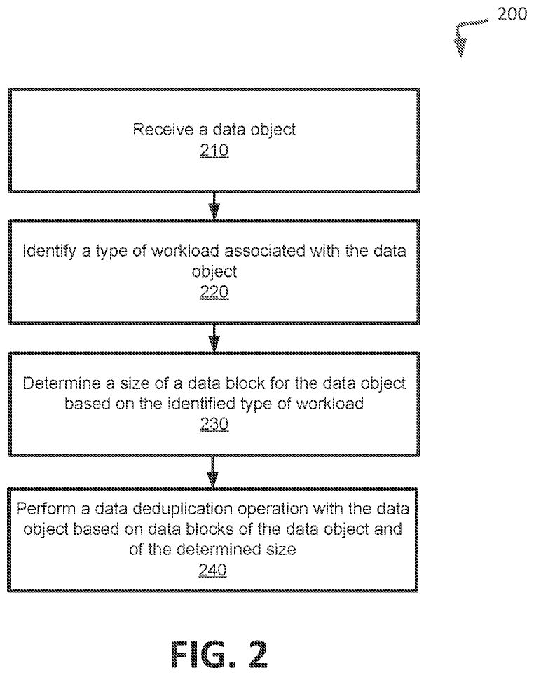

Furthermore, the host computer 110 may include a data deduplication component 124 that determines a size of a data block to be used in a data deduplication operation for data objects to be stored at the solid-state drive 120. The data deduplication component 124 may be software, hardware (e.g., a separate integrated circuit), or a combination of software and hardware that is located externally to the solid-state drive 120. Further details with regard to the data deduplication component 124 are described in conjunction with FIGS. 2-5.

Although FIG. 1 illustrates the host computer 110 coupled to the solid-state drive 120, in some embodiments, the host computer 110 may be coupled to multiple solid-state drives or other such storage devices to form a storage system or cluster. In such a case, the data deduplication component 124 may provide data deduplication operations for data objects to be stored across the various storage devices used in the storage system.

FIG. 2 is a flow diagram of an example method 200 to determine a size of a data block used in a data deduplication operation. In general, the method 200 may be performed by processing logic that may include hardware (e.g., circuitry, dedicated logic, programmable logic, microcode, etc.), software, firmware, or a combination thereof. The data deduplication component 124 of FIG. 1 may perform a portion of or all of the operations of the method 200.

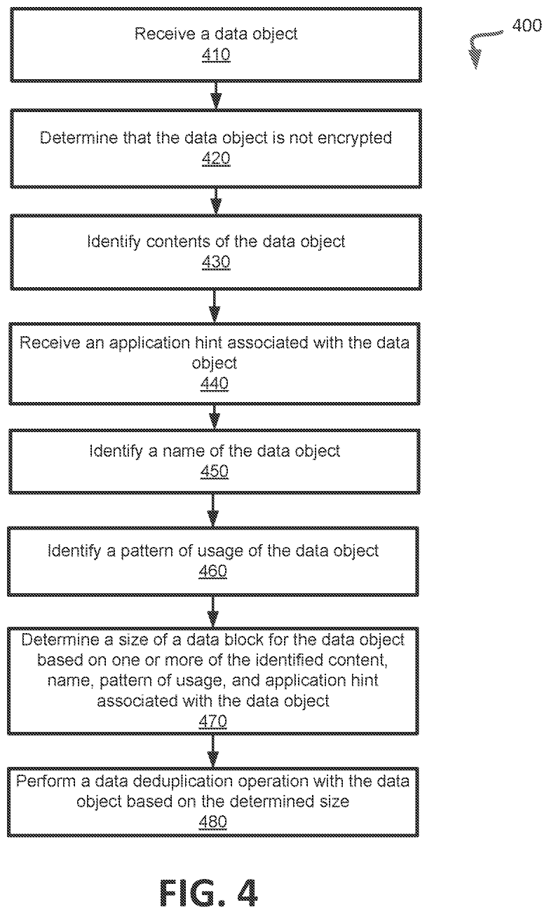

As shown in FIG. 2, the method 200 may begin with the processing logic receiving a data block (block 210). For example, a host computer or host system of a storage system may receive a file that is intended to be stored at the storage system. The processing logic may further identify a type of workload associated with the data object (block 220). The workload associated with the data object may correspond to a type of application of the host computer or host system that has generated, provided, or used the data object. Examples of such a type of application may include, but are not limited to, email applications, word processing applications, databases (e.g., online transaction processing, data warehouses, Hadoop, time series, etc.), virtual machine manager (hypervisor), operating systems (e.g., a file system), media (e.g., audio, video), social networking content (e.g., tweets, internet relay chat sessions, instant messages) and their various formats etc. Such various formats may include, but are not limited to, .gif, .jpeg, etc. for images, .iso, .qcow, .ami, etc. for virtual machines, etc. The type of the workload that is associated with the data object may be identified based on content of the data object, information from the application, a name of the data object (e.g., the file extension of the data object), a pattern of usage of the data object, etc. Further details with regards to identifying the type of the workload associated with the data object are described in conjunction with FIG. 4.

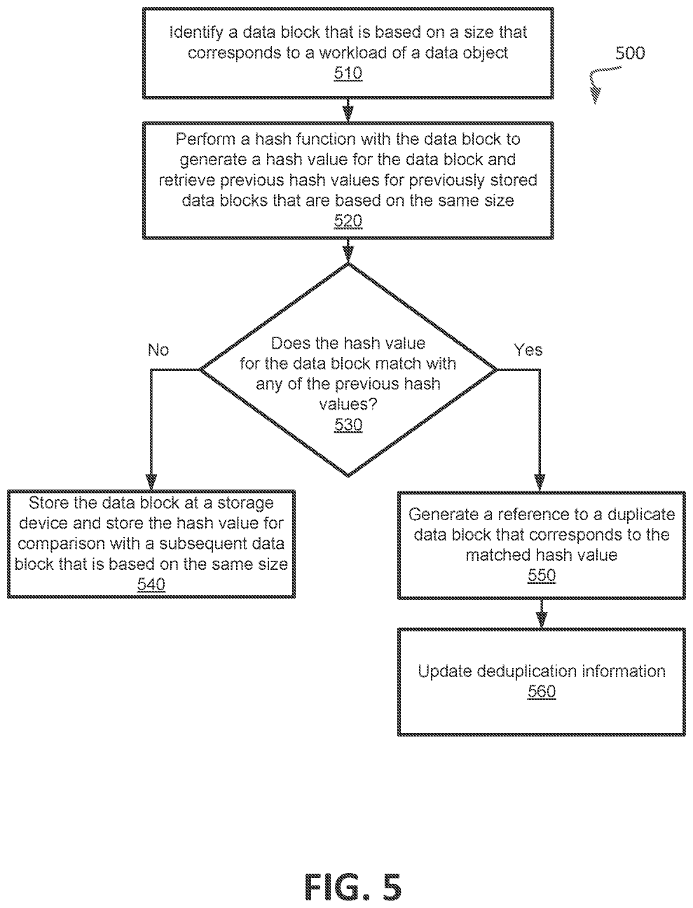

Referring to FIG. 2, the processing logic may further determine a size of a data block for the data object based on the identified type of workload (block 230). For example, the size of the data block may be assigned by using the type of workload of the data object. The data blocks may be identified as segments of the data object that are each of the determined size. Thus, multiple data blocks of a particular size, determined based on a type of workload that is associated with the data object, may be identified from a data object. Subsequently, the processing logic may perform a data deduplication operation with the data object based on data blocks of the data object of the determined size (block 240). For example, the data deduplication operation may be performed on each data block of the data object before the data block is stored at the storage system. Each data block may be of the determined size. In some embodiments, the data deduplication operation may include a calculation or generation of a hash value for each of the data blocks by using a hash function. In the same or alternative embodiments, the hash function may be used to map data of a particular size (e.g., the data block) to data of another size (e.g., the hash value). The data deduplication operation may further include a process to retrieve hash values of currently stored data blocks (e.g., previously generated hash values for previously received data blocks) and may compare the generated hash value for the received data block with the retrieved hash values of currently stored data blocks. If the hash value of the received data block matches with any of the retrieved hash values, then the received data block that was identified from the data object may be considered a duplicate of another data block currently stored at the storage system. As a result, a pointer or reference may be provided to the currently stored duplicate data block. In some embodiments, a logical address space may be used by the application that has provided, generated, or used the data object. The logical address space may include logical addresses that include pointers (i.e., references) to a physical address space that includes physical addresses that correspond to memory addresses of the storage devices or resources used in the storage system. As a result, when one of the data blocks is identified as being a duplicate of a currently stored data block, then the corresponding logical address for the data block of the data object may include a pointer to a physical address that stores the data block that was previously stored. In some embodiments, data deduplication information (e.g., a counter identifying a number of references or pointers from logical addresses to a particular physical address that indicates a number of duplicate copies) may be updated. The data deduplication information may further identify a number of times that a particular data object has been used or read. Such data deduplication information may be used to determine whether a particular data block may be deleted or is referenced by another data object. Otherwise, if the hash value for the received data block does not match with any of the hash values of the currently stored data blocks, then the data block may be stored at the storage system. Furthermore, its hash value may be used in subsequent comparisons with a subsequently received data block. Further details with regards to the data deduplication operation are described in conjunction with FIG. 5.

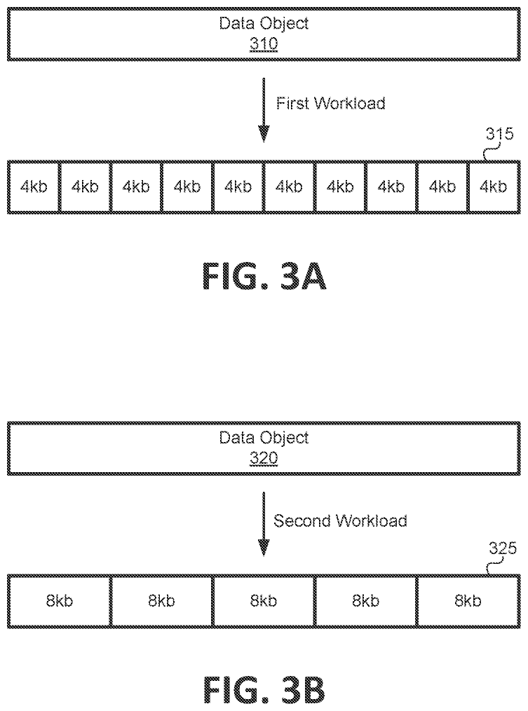

FIG. 3A illustrates an example of a separating or dividing of a data object into data blocks of a first size. In general, the data blocks of the data object may be separated or identified by the data deduplication component 124 of FIG. 1.

As shown in FIG. 3A, a data object 310 may be received by a host computer or host system. The type of workload associated with the data object 310 may be identified. Furthermore, based on the type of workload that is identified, data blocks 315 may be identified from the data object. For example, the data object 310 may be separated or divided into different data blocks 315 that are of the same size. The size of the data blocks 315 may be assigned based on the type of workload that is identified from the data object 315. For example, as shown, the data object 310 may be separated into data blocks 315 that are of a size of 4 KB. Subsequently, the data deduplication operation may be performed with each of the data blocks 315 that are of the size of 4 KB. For example, each data block 315 may be compared with another data block (or a comparison of hash values) of the same 4 KB size that was previously stored at a storage system.

FIG. 3B illustrates another example of the separating or dividing of a data object 320 into data blocks 325 of a second size. In general, the data blocks of the data object 320 may be separated or identified by the data deduplication component 124 of FIG. 1.

As shown in FIG. 3B, the data object 320 may be received and a second type of workload that is associated with the data object 320 may be identified. The second type of workload may be different than the first type of workload that was identified as being associated with the previous data object 310. For example, the data object 320 may be generated, used by, or provided by a different application than the data object 310. As a result, the data blocks 325 from the data object 320 may be of a different size than the data blocks 315 from the data object 310. For example, as shown, the data blocks 325 may be of an 8 KB size as opposed to the 4 KB size of the data blocks 315. Subsequently, the data deduplication operation may be performed with each of the data blocks 325 that are 8 KB in size (e.g., the data blocks 325 may be compared with other data blocks or hash values from previously stored data blocks that are also 8 KB in size).

As such, the size of a data block used in a data deduplication operation (e.g., a unit of deduplication) may be based on the type of workload of a data object. Furthermore, the data deduplication operation used by the storage system may change as different data objects are received. For example, the unit of deduplication used in the data deduplication operation may vary over time as different types of data objects of different types of workloads are received to be stored at the storage system.

FIG. 4 is a flow diagram of a method 400 to identify a workload of a data object. In general, the method 400 may be performed by processing logic that may include hardware (e.g., circuitry, dedicated logic, programmable logic, microcode, etc.), software, firmware, or a combination thereof. The data deduplication component 124 of FIG. 1 may perform a portion of or all of the operations of the method 400.

As shown in FIG. 4, the method 400 may begin with the processing logic receiving a data object (block 410). The data object may be provided by a particular application that is operating or associated with a host system of a storage system. The processing logic may further determine that the data object is not encrypted (block 420). For example, the data object may be analyzed to determine whether the data object has been encrypted. The data object may be identified as being encrypted by an application hint (e.g., information from or of the application that has provided the data object) or by using metadata or other such information from the data object that may include an encryption key or identification, encryption algorithm identification, or based on a pattern of bits of the data object that are random and indicative of encrypted data. If the data object is determined to be encrypted, then the data deduplication operation may not be performed on the encrypted data object and the encrypted data object may be stored. In some embodiments, the hash value of the encrypted data object may be determined and saved for subsequent comparison as part of the data deduplication operation with a subsequently received encrypted data object. Otherwise, if the data object is not encrypted, then the data deduplication operation may be performed with the data object. The processing logic may subsequently identify contents of the data object (block 430). For example, all or a portion (e.g., a header) of the contents of the data object may be parsed to identify information from the content that may correspond to particular types of workloads. In some embodiments, a data object may include a string of characters (or a workload signature) that identify the type of workload of the file. For example, a Portable Document Format (PDF) file may include a character string ‘% PDF-1.6” that may be identified from the start of the contents of the file. The workload signature may correspond to any portion of the content that is identified as being associated with a particular type of workload. The identification of the type of workload may further be based on metadata associated with the data object. In some embodiments, the contents of a first portion of the data object (e.g., a first number of data blocks) may be used to identify the type of workload of the data object. In the same or alternative embodiments, a header from the contents of the data object may be matched with known headers of data objects from known applications. The processing logic may further receive an application hint associated with the data object (block 440). For example, the application hint may correspond to an identification of an application that has provided or generated the data object. The processing logic may identify a name of the data object (block 450). For example, a file extension of the data object may be identified. In some embodiments, the file extension may be identified by a wildcard pattern match of the name of the file. The file extension may indicate a format or application that has generated the data object. The processing logic may identify a pattern of usage of the data object (block 460). The pattern of usage may correspond to a size of the data object or a number of times that data objects of a similar size have been received to be stored or retrieved as in read operations.

Referring to FIG. 4, the processing logic may determine a size of a data block for the data object based on one or more of the identified content of the data object, the name of the data object, pattern of usage of the data object, and application hint associated with the data object (block 470). For example, any combination of the content, name, pattern of usage, and application hint may be used to identify a type of workload of the data object that is used to assign the size of the data blocks for the data object. The type of workload may include, but is not limited to, media videos, source code, executable binaries, database files, audio, text documents, images, virtual machine containers or images, etc. Subsequently, the processing logic may perform a data deduplication operation with the data object based on the determined size (block 480). For example, data blocks of the determined size may be identified from the data object and the data deduplication operation may be performed with each of the identified data blocks. In some embodiments, a default size may be used to perform the data deduplication operation if the type of workload of the data object is not able to be identified as described above and when the data block is not encrypted.

FIG. 5 illustrates an example method 500 to perform a data deduplication operation based on a determined size of a data block. In general, the method 500 may be performed by processing logic that may include hardware (e.g., circuitry, dedicated logic, programmable logic, microcode, etc.), software, firmware, or a combination thereof. The data deduplication component 124 of FIG. 1 may perform a portion of or all of the operations of the method 500.

As shown in FIG. 5, the method 500 may begin with the processing logic identifying a data block that is based on a size that corresponds to a workload of a data object (block 510). For example, data blocks of a particular size may be identified from the data object. The processing logic may further perform a hash function with the data block to generate a hash value for the data block and may retrieve previous hash values for previously stored data blocks that are based on the same size (block 520). For example, previously stored data blocks of the same size as the identified data block from the data object may be identified. In some embodiments, the previously stored data blocks may be identified from previously rejected data objects having the same type of workload as a received data object. Thus, hash values for data blocks of the same size as a received data block may be retrieved. The hash values may be generated from contents of the data blocks. The processing logic may subsequently determine whether the hash value for the data block matches with any of the previous hash values for the previously stored data blocks (block 530). If the hash value for the data block does not match with any of the previously hashed values, then the processing logic may store the data block at a storage system and store the hash value for comparison with a subsequent data block that is based on the same size (block 540). For example, the data block of the data object may be stored at the storage system and the hash value for the data block may be used in a subsequent data deduplication operation with a subsequently received data block of the same data object or a subsequently received data object. Otherwise, if the hash value for the data block matches with any of the previous hash values, then the processing logic may generate a reference to a duplicate data block that corresponds to the matched hash value (block 550). For example, a pointer to the duplicate data block with the same hash value may be generated. As such, the received data block may not be stored at the storage system because a duplicate of the received data block is currently in store at the storage system. A representation of the data block may thus include a pointer to a previously stored data block. Thus, if an entire data object was a duplicate of a previously stored data object, then the representation of the data object may be a list of a single pointer to the data object previously stored. Alternately, when only portions are duplicates, the data object would be represented as a list of ordered pointers to data blocks that are currently stored at the storage system. Subsequently, the processing logic may update deduplication information (block 560). For example, a counter identifying a number of references or pointers to a particular physical address that includes the duplicate data block may be incremented.

The method 500 may be performed for each data block of a data object. For example, the method 500 may be performed for each data block of the data object where each data block is of the size that corresponds to the workload of the data object. As a result, the method 500 may be repeatedly performed for each data block of a data object until a final data block has been subjected to the data deduplication operation.

FIG. 6 is a block diagram of an example computer system associated with a solid-state drive.

As shown in FIG. 6, the computer system includes a host computer 1604 communicably coupled to a solid-state drive 602 by an I/O interface 605 or bus (e.g., via the I/O interface 115). For example, the host computer 104 may employ the system bus 105 for transferring digital information, such as data, computer-executable instructions, applications, write operations, read operations, etc., between the host computer 604 and the solid-state drive 602. The host computer 104 may also implement the data deduplication component 124. For example, the host computer 104 may implement or include processing logic that may be firmware, software, discrete logic, or an application specific integrated circuit (ASIC) or a combination thereof to implement data deduplication component 124. The solid-state drive 602 may include a solid-state drive controller 606 (e.g., an SSD controller) and a plurality of non-volatile memory packages 108.1-108.n (e.g., NAND flash packages, 3D crosspoint non-volatile memory packages, and MRAM non-volatile memory packages). The solid-state drive controller 606 may include a controller 610 communicably coupled to the I/O interface 605, a memory buffer 612, a processing device 614, control logic circuitry 616, a memory arbiter 620, and a plurality of channels 622.1-622.n communicably coupled between the memory arbiter 620 and the non-volatile memory packages 608.1-608.n, respectively.

The memory buffer 612 may be implemented using a volatile static random access memory (SRAM), or any other volatile memory, for at least temporarily storing digital information (e.g., the data, computer-executable instructions, applications, etc.) as well as context information for the solid-state drive 602. Further, the processing device 614 may be configured to execute at least one program out of at least one memory to allow the memory arbiter 620 to direct the information from the memory buffer 612 to the solid-state memory within the non-volatile memory packages 608.1-608.n via the channels 622.1-622.n. Furthermore, via the I/O interface 605, the controller 610 may receive commands issued by the host computer 604 for writing or reading the data to and from the solid-state memory within the non-volatile memory packages 608.1-608.n.

The non-volatile memory packages 608.1-608.n may each include one or more non-volatile memory dies, in which each non-volatile memory die may include non-volatile memory (e.g., NAND flash memory) configured to store digital information or data in one or more arrays of memory cells organized into one or more pages. For example, the non-volatile memory package 608.1 may include one or more non-volatile memory dies. Each of the one or more non-volatile memory dies may be used or assigned to one logical unit so that block addresses of one logical unit are not distributed between two or more logical units. Although not illustrated, the solid-state drive 602 may further include a persistent memory and a battery backed dynamic random access memory (DRAM) that may provide memory semantics and persistence beyond server power cycle operations. Examples of persistent memory include, but are not limited to Non-Volatile Dual In-line Memory Module (NVDIMM), 3D crosspoint memory, etc.

FIG. 7 is a block diagram of an example machine of a computer system 700 that is associated with a solid-state drive. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), etc.) a static memory 706 (e.g., flash memory, static random access memory (SRAM), etc.), and a data storage device 718, which communicate with each other via a bus 730. The data storage device 718 may correspond to the solid-state drive 120 of FIG. 1. In some embodiments, any or all of the main memory 704, static memory 706, and data storage device 718 may be implemented as part of the solid-state drive 120.

Processing device 702 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing operations and steps discussed herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In one implementation, the instructions 726 include instructions to implement functionality corresponding to data deduplication component (e.g., data deduplication component 124 of FIG. 1). While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

The following examples pertain to further embodiments.

Example 1 is a system comprising an interface operatively coupled to a storage resource and a processing device that is coupled with the storage resource via the interface to receive a data object associated with a request to store the data object at the storage resource, identify a type of workload associated with the data object that is associated with the request to store the data object at the storage resource, determine a size of a data block of the data object based on the identified type of workload, and perform a deduplication operation for the data object based on the determined size of the data block.

In Example 2, in the system of Example 1, to perform the deduplication operation for the data object based on the determined size of the data block, the processing device is further to identify a plurality of data blocks from the data object, wherein each of the plurality of data blocks is of the determined size, and compare the data blocks of the determined size to previously stored data blocks stored at the storage resource.

In Example 3, in the system of any of Examples 1-2, to compare the data blocks of the determined size to the previously stored data blocks stored at the storage resource, the processing device is further to generate a hash value for a particular data block of the determined size, retrieve a plurality of previous hash values for the previously stored data blocks, and determine whether the generated hash value matches with any of the previous hash values for the previously stored data blocks.

In Example 4, in the system of any of Examples 1-3, the type of workload is associated with a particular application that has generated or used the data object.

In Example 5, in the system of any of Examples 1-4, to identify the type of workload associated with the data object, the processing device is further to identify content of the data object and identify a workload signature from the content of the data object, wherein the type of workload is identified based on the identified workload signature from the content of the data object.

In Example 6, in the system of any of Examples 1-5, to identify the type of workload associated with the data object, the processing device is further to identify a file name of the data object, wherein the identifying of the type of the workload is based on a file extension of the file name of the data object.

In Example 7, in the system of any of Examples 1-6, to identify the type of workload associated with the data object, the processing device is further to receive an application hint associated with the data object, wherein the application hint corresponds to information of an application that has provided the data object, and wherein the identifying of the type of the workload is based on the application hint.

In Example 8, in the system of any of Examples 1-7, to perform the deduplication operation for the data object based on the determined size of the data block, the processing device is further to perform the deduplication for each portion of the data object corresponding to a particular data block of the determined size.

In Example 9, in the system of any of Examples 1-8, to identify the type of the workload associated with the data object, the processing device is further to identify a pattern of usage or size of the data object, wherein the identifying of the type of the workload is based on the pattern of usage or the size of the data object.

In Example 10, in the system of any of Examples 1-9, the processing device is further to determine that the data object is not encrypted, wherein the performing of the deduplication operation is further based on the data object not being encrypted.

Example 11 is an apparatus comprising a processing device, operatively coupled with a storage device, to receive a request to store a file at the storage device, identify an application associated with the file that is from the request to store the file at the storage device, determine a size of a data block of the file based on the identified application; identify a plurality of data blocks from the file, wherein each of the plurality of data blocks from the file is of the determined size, perform a deduplication operation for each of the plurality of data blocks of the determined size from the file, and store at least a portion of the plurality of data blocks from the file at the storage device based on the deduplication operation.

In Example 12, in the apparatus of Example 11, to perform the deduplication operation, the processing device is further to generate a hash value for a particular data block of the plurality of data blocks of the determined size, retrieve a plurality of previous hash values for data blocks previously stored at the storage device, and determine whether the generated hash value matches with any of the previous hash values for the previously stored data blocks.

In Example 13, in the apparatus of any of Examples 11-12, the application corresponds to a particular application that has generated or used the file.

In Example 14, in the apparatus of any of Examples 11-13, to identify the application associated with the file, the processing device is further to identify content of the file, and identify a workload signature from the content of the file, wherein the application is identified based on the identified workload signature from the content of the file.

In Example 15, in the apparatus of any of Examples 11-14, to identify the application associated with the file, the processing device is further to identify a name of the file, wherein the identifying of the application is based on a file extension of the name of the file.

In Example 16, in the apparatus of any of Examples 11-15, to identify the application associated with the file, the processing device is further to receive an application hint associated with the file, wherein the application hint corresponds to information from the request, and wherein the identifying of the application is based on the application hint.

Example 17 is a method comprising receiving a data object associated with a request to store the data object at a storage resource, identifying a type of workload associated with the data object that is associated with the request to store the data object at the storage resource, determining, by a processing device, a size of a data block of the data object based on the identified type of workload, and performing a deduplication operation for the data object based on the determined size of the data block.

In Example 18, in the method of Example 17, performing the deduplication operation for the data object based on the determined size of the data block comprises identifying a plurality of data blocks from the data object, wherein each of the plurality of data blocks is of the determined size, and comparing the data blocks of the determined size to previously stored data blocks stored at the storage resource.

In Example 19, in the method of any of Examples 17-18, comparing the data blocks of the determined size to the previously stored data blocks stored at the storage resource comprises generating a hash value for a particular data block of the determined size, retrieving a plurality of previous hash values for the previously stored data blocks, and determining whether the generated hash value matches with any of the previous hash values for the previously stored data blocks.

In Example 20, in the method of any of Examples 17-19, the type of workload is associated with a particular application that has generated or used the data object.

In Example 21, in the method of any of Examples 17-20, identifying the type of workload associated with the data object comprises identifying content of the data object, and identifying a workload signature from the content of the data object, wherein the type of workload is identified based on the identified workload signature from the content of the data object.

In Example 22, in the method of any of Examples 17-21, identifying the type of workload associated with the data object comprises identifying a file name of the data object, wherein the identifying of the type of the workload is based on a file extension of the file name of the data object.

In Example 23, in the method of any of Examples 17-22, performing the deduplication operation for the data object based on the determined size of the data block further comprises performing the deduplication for each portion of the data object corresponding to a particular data block of the determined size.

In Example 24, in the method of any of Examples 17-23, identifying the type of workload associated with the data object comprises receiving an application hint associated with the data object, wherein the application hint corresponds to information of an application that has provided the data object, and wherein the identifying of the type of the workload is based on the application hint.

Example 25 is a system on a chip (SOC) comprising a plurality of functional units and a data deduplication component, coupled to the functional units, to receive a data object associated with a request to store the data object at the storage resource, identify a type of workload associated with the data object that is associated with the request to store the data object at the storage resource, determine a size of a data block of the data object based on the identified type of workload, and perform a deduplication operation for the data object based on the determined size of the data block.

In Example 26, the SOC of Example 25 further comprises the subject matter of Examples 2-10.

In Example 27, in the SOC of any of Examples 25-26, the data deduplication component is further operable to perform the subject matter of Examples 17-24.

In Example 28, in the SOC of any of Examples 25-7, the SOC further comprises the subject matter of Examples 11-16.

Example 29 is an apparatus comprising means for receiving a data object associated with a request to store the data object at the storage resource, means for identifying a type of workload associated with the data object that is associated with the request to store the data object at the storage resource, means for determining a size of a data block of the data object based on the identified type of workload, and means for performing a deduplication operation for the data object based on the determined size of the data block.

In Example 30, in the apparatus of Example 29, the apparatus further comprising the subject matter of any of Examples 1-10 and 11-16.

Example 31 is an apparatus comprising a memory and a processor coupled to the memory and comprising a data deduplication component, wherein the data deduplication component is configured to perform the method of any of Examples 17-24.

In Example 32, in the apparatus of Example 31, the apparatus further comprises the subject matter of any of Examples 1-10 and 11-16.

Example 33 is a non-transitory machine-readable storage medium including instructions that, when accessed by a processing device, cause the processing device to perform operations comprising receiving a data object associated with a request to store the data object at the storage resource, identifying a type of workload associated with the data object that is associated with the request to store the data object at the storage resource, determining a size of a data block of the data object based on the identified type of workload, and performing a deduplication operation for the data object based on the determined size of the data block.

In Example 34, in the non-transitory machine-readable storage medium of Example 33, the operations further comprise the subject matter of any of Examples 17-24.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

What is claimed is:

1. A system comprising:
an interface operatively coupled to a storage resource; and
a processing device, coupled with the storage resource via the interface, to:
receive a data object associated with a request to store the data object at the storage resource;
identify a type of workload associated with the data object that is associated with the request to store the data object at the storage resource;
determine a size of a data block of the data object based on the identified type of workload; and
perform a deduplication operation for the data object based on the determined size of the data block.

2. The system of claim 1, wherein to perform the deduplication operation for the data object based on the determined size of the data block, the processing device is further to:
identify a plurality of data blocks from the data object, wherein each of the plurality of data blocks is of the determined size; and
compare the data blocks of the determined size to previously stored data blocks stored at the storage resource.

3. The system of claim 2, wherein to compare the data blocks of the determined size to the previously stored data blocks stored at the storage resource, the processing device is further to:
generate a hash value for a particular data block of the determined size;
retrieve a plurality of previous hash values for the previously stored data blocks; and
determine whether the generated hash value matches with any of the previous hash values for the previously stored data blocks.

4. The system of claim 1, wherein the type of workload is associated with a particular application that has generated or used the data object.

5. The system of claim 1, wherein to identify the type of workload associated with the data object, the processing device is further to:
identify content of the data object; and
identify a workload signature from the content of the data object, wherein the type of workload is identified based on the identified workload signature from the content of the data object.

6. The system of claim 1, wherein to identify the type of workload associated with the data object, the processing device is further to:
identify a file name of the data object, wherein the identifying of the type of the workload is based on a file extension of the file name of the data object.

7. The system of claim 1, wherein to identify the type of workload associated with the data object, wherein the processing device is further to:
receive an application hint associated with the data object, wherein the application hint corresponds to information of an application that has provided the data object, and wherein the identifying of the type of the workload is based on the application hint.

8. The system of claim 1, wherein to perform the deduplication operation for the data object based on the determined size of the data block, the processing device is further to:
perform the deduplication for each portion of the data object corresponding to a particular data block of the determined size.

9. The system of claim 1, wherein to identify the type of the workload associated with the data object, the processing device is further to:
identify a pattern of usage or size of the data object, wherein the identifying of the type of the workload is based on the pattern of usage or the size of the data object.

10. The system of claim 1, wherein the processing device is further to:
determine that the data object is not encrypted, wherein the performing of the deduplication operation is further based on the data object not being encrypted.

11. An apparatus comprising:
a processing device, operatively coupled with a storage device, to:
receive a request to store a file at the storage device;
identify an application associated with the file that is from the request to store the file at the storage device;
determine a size of a data block of the file based on the identified application;
identify a plurality of data blocks from the file, wherein each of the plurality of data blocks from the file is of the determined size;
perform a deduplication operation for each of the plurality of data blocks of the determined size from the file; and
store at least a portion of the plurality of data blocks from the file at the storage device based on the deduplication operation.

12. The apparatus of claim 11, wherein to perform the deduplication operation, the processing device is further to:
generate a hash value for a particular data block of the plurality of data blocks of the determined size;
retrieve a plurality of previous hash values for data blocks previously stored at the storage device; and
determine whether the generated hash value matches with any of the previous hash values for the previously stored data blocks.

13. The apparatus of claim 11, wherein the application corresponds to a particular application that has generated or used the file.

14. The apparatus of claim 11, wherein to identify the application associated with the file, the processing device is further to:
identify content of the file; and
identify a workload signature from the content of the file, wherein the application is identified based on the identified workload signature from the content of the file.

15. The apparatus of claim 11, wherein to identify the application associated with the file, the processing device is further to:
identify a name of the file, wherein the identifying of the application is based on a file extension of the name of the file.

16. The apparatus of claim 11, wherein to identify the application associated with the file, the processing device is further to:
receive an application hint associated with the file, wherein the application hint corresponds to information from the request, and wherein the identifying of the application is based on the application hint.

17. A method comprising:
receiving a data object associated with a request to store the data object at a storage resource;
identifying a type of workload associated with the data object that is associated with the request to store the data object at the storage resource;
determining, by a processing device, a size of a data block of the data object based on the identified type of workload; and
performing a deduplication operation for the data object based on the determined size of the data block.

18. The method of claim 17, wherein performing the deduplication operation for the data object based on the determined size of the data block comprises:
identifying a plurality of data blocks from the data object, wherein each of the plurality of data blocks is of the determined size; and
comparing the data blocks of the determined size to previously stored data blocks stored at the storage resource.

19. The method of claim 18, wherein comparing the data blocks of the determined size to the previously stored data blocks stored at the storage resource comprises:
generating a hash value for a particular data block of the determined size;
retrieving a plurality of previous hash values for the previously stored data blocks; and
determining whether the generated hash value matches with any of the previous hash values for the previously stored data blocks.

20. The method of claim 17, wherein the type of workload is associated with a particular application that has generated or used the data object.

21. The method of claim 17, wherein identifying the type of workload associated with the data object comprises:
identifying content of the data object; and
identifying a workload signature from the content of the data object, wherein the type of workload is identified based on the identified workload signature from the content of the data object.

22. The method of claim 17, wherein identifying the type of workload associated with the data object comprises:
identifying a file name of the data object, wherein the identifying of the type of the workload is based on a file extension of the file name of the data object.

23. The method of claim 17, wherein performing the deduplication operation for the data object based on the determined size of the data block further comprises:
performing the deduplication for each portion of the data object corresponding to a particular data block of the determined size.

24. The method of claim 17, wherein identifying the type of workload associated with the data object comprises:
receiving an application hint associated with the data object, wherein the application hint corresponds to information of an application that has provided the data object, and wherein the identifying of the type of the workload is based on the application hint.
